(19) United States
(12) Patent Application Publication
(10) Pub. No.: US 2018/0361885 A1
(43) Pub. Date: Dec. 20, 2018

(54) MOTION CONVERSION DEVICE FOR VEHICLE

(71) Applicant: AISIN SEIKI KABUSHIKI KAISHA, Kariya-shi (JP)

(72) Inventor: Sadao ITO, Anjo-shi (JP)

(73) Assignee: AISIN SEIKI KABUSHIKI KAISHA, Kariya-shi (JP)

(21) Appl. No.: 16/061,011

(22) PCT Filed: Dec. 21, 2016
(86) PCT No.: PCT/JP2016/088132

§ 371 Date: Jun. 11, 2018

(30) Foreign Application Priority Data
Dec. 25, 2015 (JP) 2015-255105

(51) Int. Cl. B60N 2/225; B60N 2/02; B60N 2/66

(52) U.S. Cl. CPC B60N 2/2251; B60N 2002/0236; B60N 2/6673; B60N 2/0232

(57) ABSTRACT

A motion conversion apparatus for a vehicle includes a fixed member including an internal gear arranged around a first axis, an input member configured to rotate about the first axis, a planetary gear including an external gear engaging with the internal gear and an output portion. The planetary gear is supported by the input member to be rotatable about a second axis arranged eccentrically relative to the first axis. In association with rotation of the input member, the planetary gear is configured to revolve around the first axis along the internal gear while self-rotating about the second axis such that the output portion performs a linear motion.

### TECHNICAL FIELD

The present invention is related to a motion conversion apparatus for a vehicle.

### BACKGROUND ART

As a motion conversion apparatus for a vehicle, an electrically-operated lumbar support apparatus described in Patent document 1 is conventionally known, for example. The apparatus is provided with a panel including an arch shape and provided at a seatback. The apparatus changes a distance between both end portions of the panel in an up and down direction to change the arch shape, and thus performs lumber support adjustment.

At the apparatus of Patent document 1, an end portion of the panel is fixedly attached to one end portion of a cable and the other end portion of the cable is fixedly attached to a rack of a gear box. The rack engages with a pinion of the gear box. When the pinion is rotated, the rotary motion is converted into a linear motion of the rack and the linear motion is transmitted to the end portion of the panel via the cable, and thus the arch shape of the panel is changed.

### DOCUMENT OF PRIOR ART

### Patent Document

Patent document 1: Japanese National Phase Laid-Open Patent Publication No. 2004-525736

### SUMMARY OF INVENTION

### Problem to be Solved by Invention

In Patent document 1, a space needed for the movement of the rack, wherein the rack performs the linear motion in association with the rotary motion of the pinion, is twice or more of a movement amount (stroke) of the rack. This is because as an engagement position with the pinion comes closer to one end portion of the rack, the engagement position becomes away from the other end portion of the rack. Accordingly, a motion conversion apparatus using a pinion and a rack unavoidably increases in size as a whole.

An objective of the present invention is to provide a motion conversion apparatus for a vehicle which can be more reduced in size as a whole.

### Means for Solving Problem

A motion conversion apparatus for a vehicle which solves the above-described problem includes a fixed member including an internal gear arranged around a first axis, an input member configured to rotate about the first axis, a planetary gear including an external gear engaging with the internal gear, and an output portion, the planetary gear being supported by the input member to be rotatable about a second axis arranged eccentrically relative to the first axis. In association with rotation of the input member, the planetary gear is configured to revolve around the first axis along the internal gear while self-rotating about the second axis such that the output portion performs a linear motion.

### BRIEF DESCRIPTION OF DRAWINGS

FIG. 1 is an exploded perspective view of a seat drive apparatus to which an embodiment of a motion conversion apparatus for a vehicle is applied.

FIG. 2 is a perspective view of the seat drive apparatus of FIG. 1.

FIG. 3 is a view of the seat drive apparatus of FIG. 2, which is seen along an axial direction.

FIG. 4 is a view illustrating a state in which a planetary gear of the seat drive apparatus of FIG. 3 revolves counter-clockwise.

FIG. 5 is an explanatory view illustrating principle of a movement of the motion conversion apparatus for a vehicle of the embodiment.

FIG. 6 is an exploded perspective view illustrating a lumbar support adjustment apparatus to which the motion conversion apparatus for a vehicle according to the embodiment is applied.

FIG. 7 is a perspective view illustrating a lock release apparatus of a recliner, to which the motion conversion apparatus for a vehicle according to the embodiment is applied.

### MODE FOR CARRYING OUT THE INVENTION

An embodiment of a motion conversion apparatus for a vehicle will be explained hereunder.

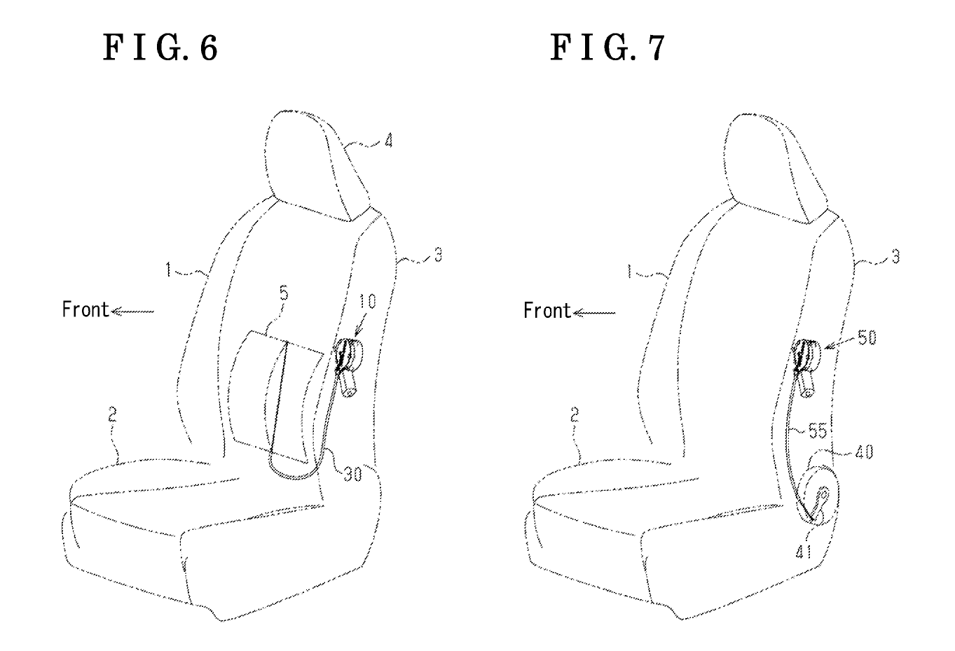

As illustrated in FIG. 6, a seat 1 on which an occupant is to be seated includes a seat cushion 2 forming a seating surface, a seatback 3 supported at a rear end portion of the seat cushion 2 and a headrest 4 supported at an upper end portion of the seatback 3.

The seatback 3 includes a panel 5 built in the seatback 3. The panel 5 is formed in a substantially quadrangular plate shape and includes a surface facing a front and rear direction. The panel 5 is curved to include an arch shape protruding in a front direction. The panel 5 includes an upper end and a lower end. As a position of the lower end is changed in an up and down direction relative to the upper end, a distance between the upper end and the lower end is changed, and thus the arch shape of the panel 5 is changed. Accordingly, lumber support adjustment is performed such that a more favorable state for the occupant is obtained.

A seat drive apparatus 10 is built in a side portion at one side (the left side when facing the front direction of the seat 1) of the seatback 3. An output portion of the seat drive apparatus 10 is connected to a lower end of the panel 5 via a cable 30 which is a push-pull cable. The seat drive apparatus 10 causes the cable 30 to move back and forth, thereby pushing and pulling the lower end of the panel 5, and thus the seat drive apparatus 10 changes the arch shape of the panel 5.

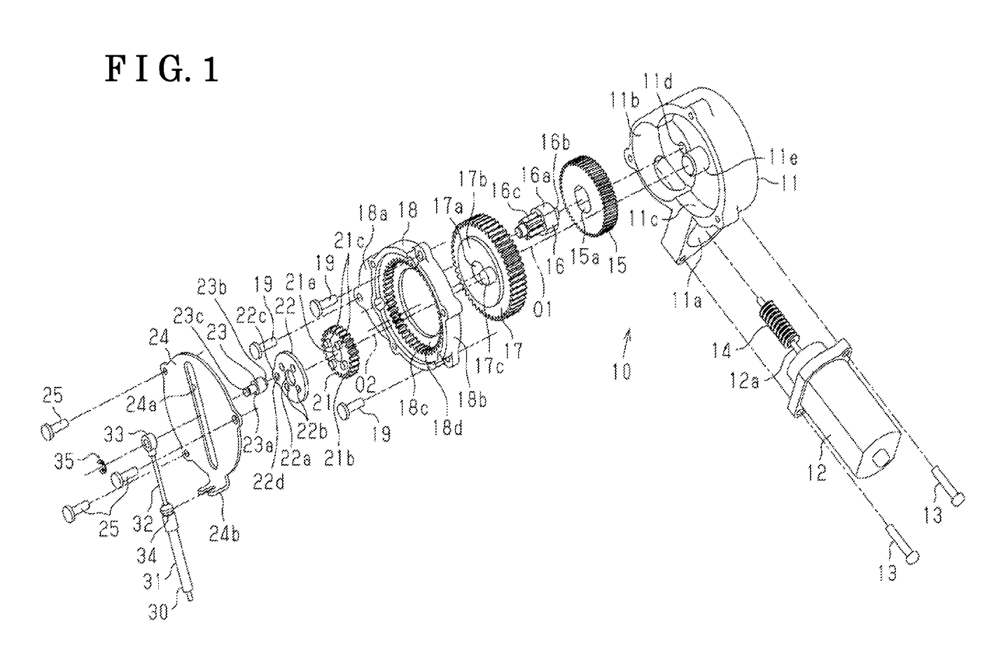

As illustrated in FIG. 1, the seat drive apparatus 10 includes a main body case 11 forming an outer shape of the seat drive apparatus 10. The main body case 11 includes a first accommodation portion 11a including a substantially cylindrical shape opening towards a first direction (the obliquely lower right direction in FIG. 1), and a second accommodation portion 11b and a third accommodation portion 11c each including a substantially cylindrical shape opening towards a second direction (the obliquely lower left direction in FIG. 1) which is orthogonal to the first direction. An inner diameter of the first accommodation portion 11a is set to be sufficiently smaller than an inner diameter of the second accommodation portion 11b. The inner diameter of the second accommodation portion is set to be smaller than an inner diameter of the third accommodation portion 11c. The first and second accommodation portions 11a and 11b are in communication with each other in a state where respective inner peripheral surfaces of the first and second accommodation portions 11a and 11b partly overlap with each other. The second and third accommodation portions 11b and 11c are in communication with each other in a state where respective inner peripheral surfaces of the second and third accommodation portions 11b and 11c partly overlap with each other. A bearing hole 11d which is coaxial with the second accommodation portion 11b and includes a substantially circular shape is provided at a bottom portion of the second accommodation portion 11b. A support shaft 11e which is coaxial with the third accommodation portion 11c and includes a substantially circular column shape is provided at a bottom portion of the third accommodation portion 11b in a protruding manner.

A motor 12 is fastened to the main body case 11 with plural screws 13. The motor 12 serving as an electric drive source is coaxial with the first accommodation portion 11a and is fixed to an opening end of the first accommodation portion 11a. A worm 14 including a substantially cylindrical shape is accommodated in the first accommodation portion 11a, and a rotary shaft 12a of the motor 12 is fixed to the worm 14 by press-fitting such that the rotary shaft 12a and the worm 14 rotate integrally with each other. A worm wheel 15 including a substantially cylindrical shape and engaging with the worm 14 is rotatably accommodated in the second accommodation portion 11b. The worm wheel 15 is provided with a fitting hole 15a which is coaxial with the bearing hole 11d and includes a substantially elongated circular shape penetrating a central portion of the worm wheel 15. A pinion 16 is connected to the worm wheel 15 such that the pinion 16 rotates coaxially and integrally with the worm wheel 15. The pinion 16 includes integrally therewith a fitting portion 16a, a shaft portion 16b and a gear portion 16c. The fitting portion 16a is fitted into the fitting hole 15a and includes a columnar shape of which a cross section is substantially elongated circular shape. The shaft portion 16b includes a substantially circular column shape and includes an outer diameter which is equivalent to the inner diameter of the bearing hole 11d. The shaft portion 16b is provided at the fitting portion 16a so as to protrude. The gear portion 16c is provided at the fitting portion 16a so as to protrude, at a side opposite to the shaft portion 16b. As the shaft portion 16b of the pinion 16 is inserted in the bearing hole 11d and is supported thereat, the worm wheel 15 is rotatable integrally with the pinion 16 inside the second accommodation portion 11b. The bottom portion of the third accommodation portion 11c is raised relative to the bottom portion of the second accommodation portion 11b by a dimension (by thickness) of the worm wheel 15 in an axial direction. Thus, the support shaft 11e and the gear portion 16c are arranged side by side in a radial direction thereof.

A gear 17 which includes a substantially cylindrical shape and serves as an input member engaging with the gear portion 16c is rotatably accommodated in the third accommodation portion 11c. The gear 17 is formed with a bearing hole 17a formed in a substantially circular shape. The bearing hole 17a includes an inner diameter which is equivalent to an outer diameter of the support shaft 11e and penetrates at a central portion of the gear 17. As the support shaft 11e is inserted in the bearing hole 17a, the gear 17 is rotatable inside the third accommodation portion 11c about a first axis O1. The gear 17 includes a step portion 17b protrudingly provided around the bearing hole 17a so as to be coaxial with the first axis O1. The step portion 17b includes a substantially annular shape. The gear 17 also includes a support shaft 17c protrudingly provided on the step portion 17b. The support shaft 17c is formed in a substantially circular column shape including an axis which is parallel to the first axis O1.

A ring gear 18 serving as a fixed member is fastened with plural screws 19 to an opening end of the main body case 11 (the second accommodation portion 11b, for example) in which, for example, the worm wheel 15 is accommodated. The ring gear 18 includes a lid portion 18a blocking or closing the second accommodation portion 11b. The ring gear 18 integrally includes an annular portion 18b opening the third accommodation portion 11c. An internal gear 18c is formed at an inner peripheral portion of the annular portion 18b over the entire periphery of the annular portion 18b. The internal gear 18c is arranged to be coaxial with the gear 17. At the annular portion 18b, a flange 18d is formed at an opening end which faces the gear 17. The flange 18d faces inward and includes an inner diameter which is equivalent to an outer diameter of the step portion 17b. As an outer peripheral surface of the step portion 17b is in contact with the inner peripheral surface of the flange 18d in a slidable manner, the annular portion 18b restricts an axial misalignment of the gear 17 from occurring. The support shaft 17c is positioned within a space portion surrounded by the internal gear 18c.

For example, when the motor 12 (the rotary shaft 12a) rotates in one direction, the rotation is decelerated and transmitted to the pinion 16 via the worm 14 and the worm wheel 15. The rotation of the pinion 16 is further decelerated between the gear 17 and is transmitted to the gear 17. Together with the worm 14, the worm wheel 15 and the pinion 16, the gear 17 forms a decelerator which decelerates the rotation of the motor 12.

A planetary gear 21 including a substantially cylindrical shape is supported at the support shaft 17. The planetary gear 21 is provided with a bearing hole 21a formed in a substantially circular shape and including an inner diameter which is equivalent to an outer diameter of the support shaft 17c. The support shaft 17c is rotatably inserted in the bearing hole 21a. The planetary gear 21 includes an external gear 21b formed along over the entire periphery of an outer peripheral portion of the planetary gear 21, and the external gear 21b engages with the internal gear 18c. Accordingly, the planetary gear 21 revolves about the first axis O1 along the internal gear 18c while self-rotating about a second axis O2 (the support shaft 17c) which is eccentric relative to the first axis O1. A diameter D2 of a pitch circle of the external gear 21b is set to be one half, that is, ½ of a diameter D1 of a pitch circle of the internal gear 18c. The planetary gear 21 includes plural (four in the present embodiment) fixing protrusions 21c arranged around the bearing hole 21a at equal angular intervals. Each of the fixing protrusions 21c includes a substantially circular column shape. Each of the fixing protrusions 21c is parallel to the second axis O2 and extends towards a side opposite to the gear 17.

A relay plate 22 including a substantially annular shape and is fixed to the planetary gear 21 so as to rotate integrally with the planetary gear 21. The relay plate 22 is fixed to the planetary gear 21 in a manner that the relay plate 22 is overlapped with the planetary gear 21 in the axial direction. The relay plate 22 is provided with a through hole 22a which is coaxial with the bearing hole 21a and includes a substantially circular shape. The relay plate 22 is also provided with plural (four in the present embodiment) fixing holes 22b which are arranged around the through hole 22a at equal angular intervals and each of which includes a substantially circular shape. The fixing holes 22b face the respective fixing protrusions 21c, and inner diameters of the respective fixing holes 22b are set to be equivalent to outer diameters of the respective fixing protrusions 21c. As each of the fixing protrusions 21c is fitted into the corresponding fixing hole 22b, the relay plate 22 rotates integrally with the planetary gear 21. The relay plate 22 includes an attachment piece 22c formed in a substantially tongue-shape and extending radially outwardly at a predetermined angular position. The attachment piece 22c is formed with an attachment hole 22d including a substantially circular shape.

An output pin 23 serving as the output portion and including an axis which is parallel to the second axis O2 is fixedly attached to the relay plate 22. The output pin 23 includes a substantially circular stepped-column shape. The output pin 23 includes a main body 23a formed in a substantially circular column shape of which an outer diameter is larger than an inner diameter of the attachment hole 22d. The output pin 23 also includes an attachment portion 23b which is formed in a substantially circular column shape, of which an outer diameter is equivalent to the inner diameter of the attachment hole 22d, and which is provided to protrude from the main body 23a towards the attachment hole 22d. In a state in which the attachment portion 23b is inserted in the attachment hole 22d, the output pin 23 is fixedly attached to the relay plate 22 by, for example, crimping or welding. The center of the output pin 23 is positioned on the pitch circle of the external gear 21b. The output pin 23 includes a circular column portion 23c formed in a substantially circular column shape and having an outer diameter which is smaller than the outer diameter of the main body 23a. The circular column portion 23c is formed to protrude from the main body 23a towards a side opposite to the attachment portion 23b.

It is known that, as illustrated in FIG. 5, when a circle (a rolling circle) Cm rolls along an inner side of a circle (fixed circle) Cr that is fixed, if a diameter of the circle Cm is one half of a diameter of the circle Cr, a cycloid (hypocycloid) traced by a point on the circle Cm is a straight line. For example, in a case where a point P on the circle Cm is chosen on a straight line L1 passing a contact point CN of the circles Cr and Cm, and a center O of the circle Cm, the point P traces or draws a straight line L2 which is orthogonal to the straight line L1. The straight line L2 is naturally positioned on the diameter of the circle Cr. In FIG. 5, positions a, b, c and d of the circle Cm and positions Pa, Pb, Pc and Pd of the corresponding point P are illustrated, wherein the positions a, b, c and d differ from one another. As is clear from FIG. 5, when the circle Cm is displaced to the positions a to d along the circle Cr, the point P is displaced to the positions Pa to Pd along the straight line L2.

Consequently, in a case where the circle Cr and the circle Cm are regarded as the pitch circle of the internal gear 18c and the pitch circle of the external gear 21b, respectively, and the contact point CN is regarded as an engaging position of the external gear 21b and the internal gear 18c, the center O can be regarded as the center (the axis) of the support shaft 17c (the bearing hole 21a) and the point P can be regarded as the center (the axis) of the output pin 23. A distance L from the center of the supporting shaft 17c and the center of the output pin 23 coincides with a radius of the pitch circle of the external gear 21b. When the planetary gear 21 revolves counter-clockwise in the drawing along the internal gear 18c while the planetary gear 21 is self-rotating about the support shaft 17c, the center of the output pin 23 (that is, the point P) performs a linear motion along the straight line L2. That is, the output pin 23 performs the linear motion along the straight line L2 that is perpendicular to the first axis O1 and intersects with the first axis O1.

For example, when the planetary gear 21 revolves along the internal gear 18c counter-clockwise in FIG. 5 by 90 degrees, the center of the output pin 23 moves to the position Pd. When the planetary gear 21 further revolves and comes to a position of 180 degrees, the center of the output pin 23 moves to the original position Pa. When the planetary gear 21 comes to a position of 270 degrees, the center of the output pin 23 moves to a position Pd′ which is on the pitch circle at a side opposite to the position Pd. When the planetary gear 21 comes to a position of 360 degrees, the center of the output pin 23 moves to the original position Pa again.

As illustrated in FIG. 1, a lid member 24 including a substantially disc shape is fastened with plural screws 25 to an opening end of the ring gear 18 in which, for example, the planetary gear 21 is accommodated, and thus the opening end is closed or blocked with the lid member 24. The lid member 24 is formed with an elongated hole 24a in which the circular column portion 23c of the output pin 23 is to be loosely inserted. The elongated hole 24a is extended along a movement trajectory (the straight line L2) of the output pin 23 (the point P) that is obtained in association with the above-described revolution of the planetary gear 21, and the elongated hole 24a allows the output pin 23 to perform the linear motion. Accordingly, an overall length of the elongated hole 24a is set to be greater than a length obtained by adding the diameter of the output pin 23 (the circular column portion 23c) to the diameter D1 of the pitch circle of the internal gear 18c. The lid member 24 includes a locking piece 24b provided at an outer peripheral portion of the lid member 24 to be positioned on an extended line of an end point of the elongated hole 24 at one side. The locking piece 24b includes a substantially U shape and is formed to protrude towards a side opposite to the ring gear 18.

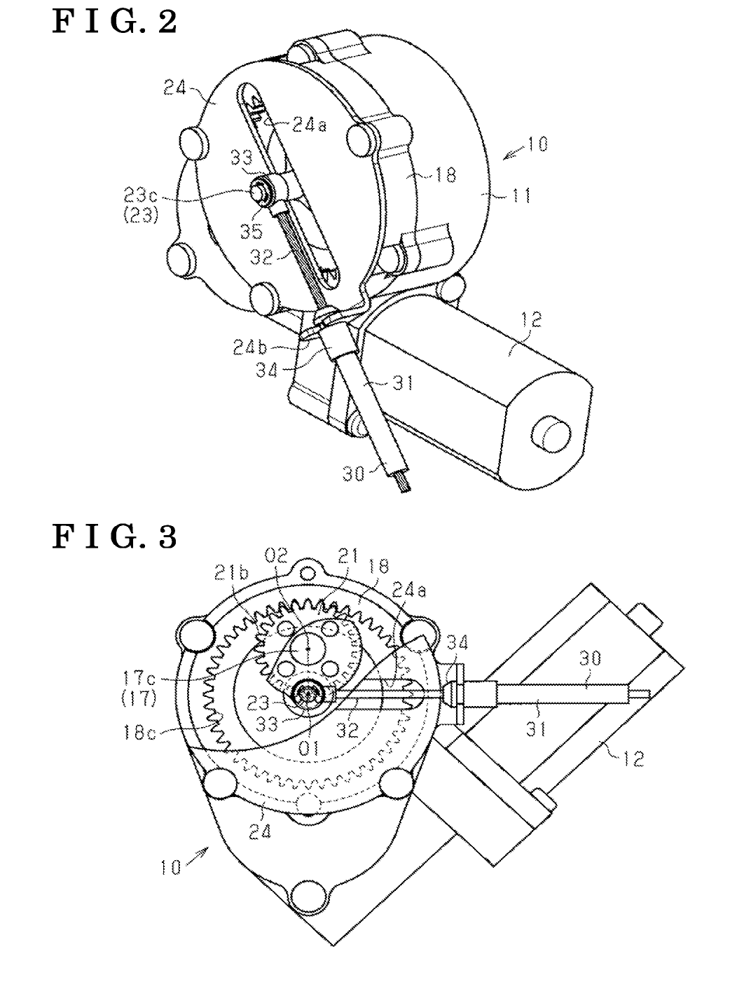

The cable 30 is connected to a distal end portion of the circular column portion 23c passing through the elongated hole 24a. That is, as illustrated in FIG. 2, the cable 30 includes an outer tube 31, a cable core portion 32, a cable terminal portion 33 and an outer tube locking portion 34. The cable core portion 32 is protected by the outer tube 31, and is movable back and forth to come out of the outer tube 31 and be retracted inside the outer tube 31. The cable terminal portion 33 includes a substantially cylindrical shape and is fixedly attached to a distal end of the cable core portion 32. The outer tube locking portion 34 is attached to a distal end of the outer tube 31. The cable terminal portion 33 includes an inner diameter which is equivalent to an outer diameter of the circular column portion 23c and is arranged coaxially with the circular column portion 23c. The circular column portion 23c is rotatably fitted in the cable terminal portion 33 by insertion, in a state where the outer tube locking portion 34 is locked at the locking piece 24b. As a retaining ring 35 including a substantially C-shape is attached, by fitting, to the distal end portion of the circular column portion 23c passing through the cable terminal portion 33, the circular column portion 23c is prevented from pulling off the cable terminal portion 33.

In the above-described configuration, as illustrated in FIG. 3, it is assumed that the output pin 23 is positioned at a center (the first axis O1) of the internal gear 18c, for example. It is also assumed that the engaging position of the external gear 21b and the internal gear 18c with each other is at a position away from the position of the output pin 23 towards a direction which is orthogonal to a moving direction of the output pin 23.

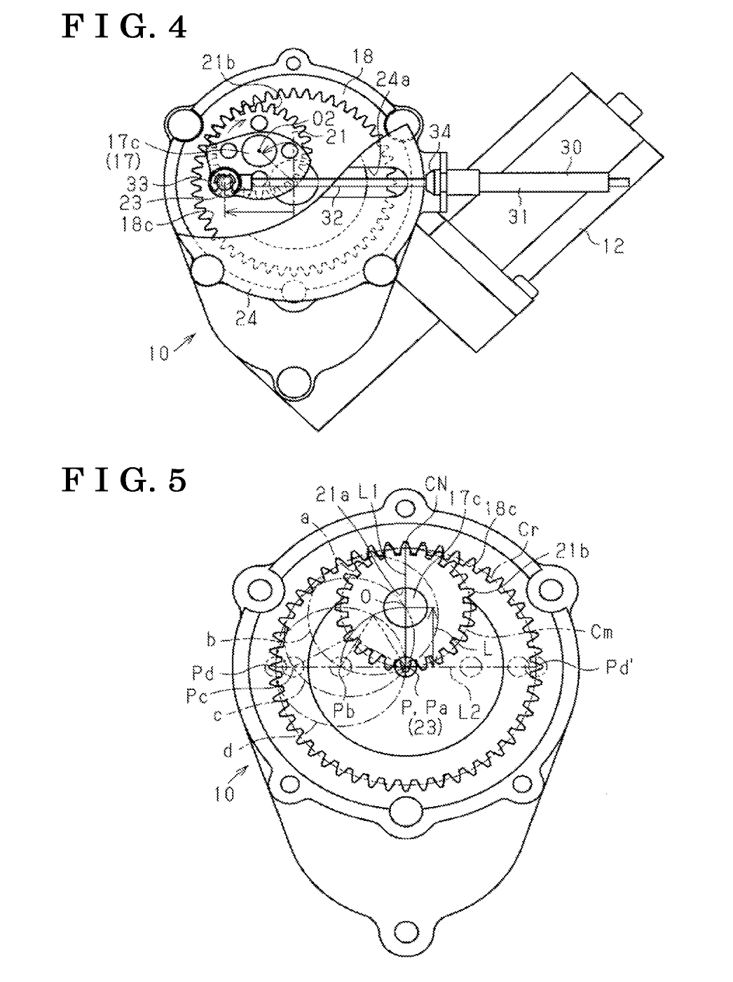

In the above-described state, when the support shaft 17c revolves counter-clockwise about the first axis O1 in association with the rotation of the gear 17, the planetary gear 21 revolves counter-clockwise about the first axis O1 along the internal gear 18c while performing the self-rotation about the support shaft 17c (the second axis O2) in the clockwise direction, as illustrated in the change from FIG. 3 to FIG. 4. Thus, the output pin 23 moves (performs the linear motion) along the elongated hole 24a towards a side (the left side in the drawing) at which the output pin 23 becomes away from the outer tube locking portion 34, and accordingly the cable core portion 32 is pulled out from the outer tube 31 by the movement amount. When the output pin 23 moves along the elongated hole 24a towards a side (the right side in the drawing) at which the output pin 23 comes close the outer tube locking portion 34, the cable core portion 32 is pushed back to the inside the outer tube 31 by the movement amount.

The lower end of the panel 5 is connected to the cable core portion 32. Thus, for example, when the cable core portion 32 is pulled out from the outer tube 31 by the movement amount of the output pin 23, the lower end of the panel 5 is pulled by the cable core portion 32. To the contrary, when the cable core portion 32 is pushed back into the outer tube 31 by the movement amount of the output pin 23, the lower end of the panel 5 is pushed by the cable core portion 32. As described above, by pushing and pulling the cable core portion 32, the arch shape of the panel 5 is changed.

Next, operation and effect of the present embodiment will be described.

(1) In the present embodiment, even if the size of the gear 17 is as much as the inner diameter of the internal gear 18c, when the planetary gear 21 is revolved along the internal gear 18c, the output pin 23 can perform the linear motion by the movement amount which is as much as the inner diameter of the internal gear 18c. Consequently, the apparatus can be reduced more in size as a whole.

(2) In the present embodiment, the diameter D2 of the pitch circle of the external gear 21b is set to be a half of the diameter D1 of the pitch circle of the internal gear 18c, and the output pin 23 is arranged on the pitch circle of the external gear 21b. Accordingly, as the planetary gear 21 revolves along the internal gear 18c while self-rotating about the second axis O2, the linear motion of the output pin 23 can be naturally realized.

(3) In the present embodiment, a direction of the linear motion of the output pin 23 can be switched only by rotating the gear 17 in one direction. That is, the output pin 23 is allowed to perform the linear reciprocating motion by rotating the gear 17 only in one direction. Consequently, for example, in a case where the gear 17 is rotated by the motor 12, there is no need to switch a direction of rotation of the motor 12 and/or to detect the switching position. Thus, components, including a switch, which are needed to rotate the motor 12 forward and backward can be omitted. Consequently, an electrical circuit configuration can be more simplified, thereby reducing costs.

In addition, for example, unlike the case of Patent document 1 in which the rotary motion is converted into the linear motion with the use of the pinion and the rack as described in the [BACKGROUND ART], there is no need to restrict an amount of movement of the rack by providing a contact portion (a stopper) at a distal end of the rack wherein the rack and the pinion are in contact with each other at the contact portion. Accordingly, a large stress associated with the contact is not generated at the seat drive apparatus 10, and thus the apparatus is restricted from being worn and/or a life of the apparatus can be made longer. Strength required for the seat drive apparatus 10 an be reduced.

(4) In the present embodiment, because of the relay plate 22, the output pin 23 can be arranged in a deviated manner in the direction of the second axis O2 relative to the external gear 21b even in a case where the output pin 23 is arranged on the pitch circle of the external gear 21b. Consequently, for example, the linear motion of the output pin 23 can be realized without obstructing the engagement of the external gear 21b and the internal gear 18c with each other.

(5) In the present embodiment, the circular column portion 23c (the output pin 23) is supported by the cable terminal portion 33 fixedly attached to the cable core portion 32. Here, when the output pin 23 is caused to perform the linear motion in association with the rotational drive of the gear 17, the output pin 23 (the circular column portion 23c) self-rotates about the axis of the output pin 23 of its own in association with the revolution of the planetary gear 21. However, the rotations of the output pin 23 can be absorbed by the cable terminal portion 33 because the cable core portion 32 (the portion serving as an object of the drive) connected to the output pin 23 is provided with the cable terminal portion 33 (a bearing portion). Therefore, the movement along the direction of the linear motion can be enabled without causing a connecting portion, where the cable 30 is connected to the output pin 23, to swing about the axis of the output pin 23.

(6) In the present embodiment, the linear motion of the output pin 23 is transmitted to the cable 30 as it is, and the cable 30 can be pulled and pushed. Accordingly, for example, unlike a case where an appropriate lever connected to the cable (the cable core portion) is rotated to push and pull the cable, an arrangement space allowing the rotation of the lever does not need to be provided and/or resistance of the cable is not varied by the change of an angle at which the cable is pulled depending on a rotary position of the lever. In addition, there is no need to separating a fastening position (which corresponds to the outer tube locking portion 34) of the cable from the lever to inhibit the change of the angle. Consequently, the cable 30 can be arranged in the vicinity of the seat drive apparatus 10 in an integrated manner, thereby further reducing the space for the routing of the cable 30.

(7) In the present embodiment, the linear motion can be obtained only from the rolling motion (the self-rotation and the revolution) of the planetary gear 21 that is associated with the rotation of the gear 17, and thus the conversion apparatus with high efficiency and small loss caused by the wear. Consequently, for example, the motor 12 can be downsized, thereby saving weight and costs.

The aforementioned embodiment can be changed or modified as follows.

As illustrated in FIG. 7, the motion conversion apparatus for a vehicle can be applied to a lock release apparatus of a recliner. That is, an appropriate recliner (a lock mechanism) 40 is provided between the seat cushion 2 and the seatback 3. The recliner 40 restricts and/or allows a relative rotation of the seatback 3 relative to the seat cushion 2. The recliner 40 is normally in a restricted state of the relative rotation and includes a release lever 41 for inputting an operation force which releases the restricted state. When the recliner 40 receives the operation force rotating the release lever 41, the recliner 40 is switched to be in an allowed state of the relative rotation.

A seat drive apparatus 50 including the configuration conforming to the seat drive apparatus 10 is built in the side portion of the seatback 3 at one side (the left side when facing the front direction of the seat 1). An output portion (which corresponds to the output pin 23) of the seat drive apparatus 50 is connected to a distal end of the release lever 41 via a cable 55 including the configuration conforming to the cable 30. The seat drive apparatus 50 causes the cable 55 to move back and forth, thereby pushing and pulling the distal end of the release lever 41, and thus the recliner 40 is switched to the restricted state or the allowed state. The occupant can adjust a tilt angle of the seatback 3 by using the function of the recliner 40.

The motion conversion apparatus for a vehicle may be applied to a release apparatus of a seat lock related to attachment and detachment of the seat itself and/or a release apparatus of a seatback lock engaging and disengaging the seatback with a striker of a body, in addition to the lock release apparatus of the recliner. Alternatively, the motion conversion apparatus for a vehicle may be applied to a release apparatus of, for example, a door lock engaging and disengaging a door of a vehicle with a striker of a vehicle body.

In the aforementioned embodiment, the support shaft 17c is protrudingly provided at the gear 17 and the bearing hole 21a supporting the support shaft 17c is formed at the planetary gear 21, however, the relation thereof may be reversed to each other. That is, the bearing hole may be formed at the gear 17 and the support shaft supported by the bearing hole may be protrudingly provided at the planetary gear 21.

In the aforementioned embodiment, the output pin 23 (the circular column portion 23c) may include a circular cylindrical shape and/or a circular truncated cone shape, a polygonal frustum shape or a polygonal prism shape, for example. In particular, in a case where the output pin 23 includes the frustum shape or the polygonal prism shape, it is desirable that an appropriate play is provided between the output pin 23 and the cable 30 (the cable terminal portion 33), so that the rotation of the output pin 23 is not transmitted to the cable 30 (the cable terminal portion 33) and does not make the cable 30 to rotate.

In the aforementioned embodiment, the output pin 23 (the circular column portion 23c) is protrudingly provided at the relay plate 22 and the cable terminal portion 33 (the bearing portion) supporting the output pin 23 (the circular column portion 23c) is provided at the cable 30, however, the relation thereof may be reversed to each other. That is, the bearing hole (the bearing portion) may be formed at the relay plate 22 and the circular column portion supported by the bearing hole (the bearing portion) may be provided in the protruding manner at the cable 30.

In the aforementioned embodiment, the relay plate 22 may be omitted and the output pin (23) may be protrudingly provided directly at the planetary gear 21. In this case, it is desirable that the output pin is extended from the external gear 21b at a radially inward side relative to the pitch circle of the external gear 21b, and that the circular column portion of the output pin at a distal end side is bent in, for example, a crank-shape such that the circular column portion is positioned on the pitch circle.

In the aforementioned embodiment, the output pin 23 is caused to perform the linear reciprocating motion by driving the gear 17 and so forth to rotate only in one direction. To the contrary, the output pin 23 may be caused to perform the linear reciprocating motion by driving the motor 12 to rotate in a normal direction and a reverse direction, based on the premise that a rotation range of, for example, the gear 17 is limited. In this case, an opening width of the elongated hole 24a in an extending direction can be smaller than the original maximum movement amount of the output pin 23. For example, the rotation direction of the motor 12 may be switched at a timing (or at a timing prior thereof) when the output pin 23 reaches an end portion of the elongated hole 24a and thus the output pin 23 is mechanically restricted from moving.

In the aforementioned embodiment, the attachment point (the output pin 23) of the cable 30 is arranged on the movement trajectory of the pitch circle of the external gear 21b (the rolling circle). However, even if the attachment point (the output pin 23) of the cable 30 is slightly deviated from the movement trajectory of the pitch circle of the external gear 21b (the rolling circle), the behavior of the output pin 23 is only a gentle curved motion (which can be substantially regarded as the linear motion) instead of the linear motion, which does not cause any problem to the operation of the cable 30.

In the aforementioned embodiment, plural output pins (23) rotating integrally with the planetary gear 21 and plural cables (30) connected to the respective output pins may be provided. In this case, by arranging the plural output pins on the pitch circle of the external gear 21b at different angular positions from each other, the plural cables connected to the respective output pins are allowed to move back and forth in such a manner that a phase difference is generated between the cables.

In the aforementioned embodiment, the configuration of the decelerator that reduces the speed of the rotation of the motor 12 (the rotary shaft 12a) and transmits the decelerated rotation to the gear 17 is an example. For example, in a case where a rated output of the motor 12 is high enough, it may be configured such that the decelerator is omitted and the motor 12 directly drives the gear 17 to rotate.

In the aforementioned embodiment, it may be configured such that the motor 12 is omitted and an appropriate input member corresponding to the gear 17 is manually rotated to drive, directly or indirectly.

In the aforementioned embodiment, for example, the seat drive apparatus 10 may be used for a side support adjustment apparatus for adjusting a holding performance of a seat which holds the occupant. The seat drive apparatus 10 may be used for a headrest height adjustment apparatus for adjusting a position of the headrest 4 in the up-and-down direction. The seat drive apparatus 10 may be used for an appropriate adjustment apparatus other than the above-described apparatuses.

1. A motion conversion apparatus for a vehicle, the apparatus comprising:
a fixed member including an internal gear arranged around a first axis;
an input member configured to rotate about the first axis;
a planetary gear including an external gear engaging with the internal gear, and an output portion;
the planetary gear being supported by the input member to be rotatable about a second axis arranged eccentrically relative to the first axis; and
in association with rotation of the input member, the planetary gear being configured to revolve around the first axis along the internal gear while self-rotating about the second axis such that the output portion performs a linear motion.

2. The motion conversion apparatus for a vehicle according to claim 1, wherein the output portion is configured to perform the linear motion along a straight line which is perpendicular to the first axis and intersects with the first axis.

3. The motion conversion apparatus for a vehicle according to claim 1, wherein
a diameter of a pitch circle of the external gear is set to be one half of a diameter of a pitch circle of the internal gear, and
the output portion is arranged on the pitch circle of the external gear.

4. The motion conversion apparatus for a vehicle according to claim 1, wherein the output portion is configured to perform the linear motion in a reciprocating manner in association with the rotation of the input member in one direction.

5. The motion conversion apparatus for a vehicle according to claim 1, the apparatus comprising:
a relay plate configured to rotate integrally with the planetary gear,
wherein the output portion is fixedly attached to the relay plate.

6. The motion conversion apparatus for a vehicle according to claim 1, wherein the output portion corresponds to either a circular column portion including an axis which is parallel to the second axis or a bearing portion supporting the circular column portion.
